(19) United States
(12) Patent Application Publication
(10) Pub. No.: US 2023/0112486 A1
(43) Pub. Date: Apr. 13, 2023

(54) SYSTEM AND METHOD FOR BUILDING TEAMS

(71) Applicant: UNIVERSITY OF SOUTH CAROLINA, Columbia, SC (US)

(72) Inventors: BIPLAV SRIVASTAVA, CHAPIN, SC (US); TARMO KOPPEL, COLUMBIA, SC (US); MICHAEL N. HUHNS, BLYTHEWOOD, SC (US); MICHAEL A. MATTHEWS, COLUMBIA, SC (US); PAUL ZIEHL, IRMO, SC (US); DANIELLE MCELWAIN, BLYTHEWOOD, SC (US)

(21) Appl. No.: 17/953,593

(22) Filed: Sep. 27, 2022

Related U.S. Application Data
(60) Provisional application No. 63/255,130, filed on Oct. 13, 2021.

(51) Int. Cl. G06Q 10/06; G06Q 10/10

(52) U.S. Cl. CPC G06Q 10/063112; G06Q 10/103

(57) ABSTRACT

The disclosure deals with a system and method for building teams in response to a teaming opportunity. In one exemplary embodiment disclosed herewith, a system and method for building teams for Request for Proposals (RFPs) is described where potential team participants are researchers at one or more institutions. A computer-based method and computer system, given RFPs from funding agencies like NSF, DOE and NASA, recommends a team of experts from various faculties and departments of the organization, like a university, that would best fit the needs of the RFP and have a high chance of putting a successful proposal together. The system generates teams that may match the requirements of an RFP. In addition, the system optimizes the list of teams to maximize winning success and to reduce redundancy. The system input includes RFPs and the researchers' public information. The system output is a list of proposed teams, each team with two or more members. Optionally, each team will have an estimation of the team's budget and proposal success chances. The disclosed methodology is more broadly applicable to team-building opportunities in general.

### PRIORITY CLAIM

The present application claims the benefit of priority of U.S. Provisional Patent Application No. 63/255,130, titled “System and Method for Building Teams,” filed Oct. 13, 2021, which is fully incorporated herein by reference for all purposes.

### BACKGROUND OF THE PRESENTLY DISCLOSED SUBJECT MATTER

The disclosure deals with a system and method for building teams in response to a teaming opportunity. In one exemplary embodiment disclosed herewith, a system and method for building teams for request for proposals (RFPs) is described. It is to be understood that while such exemplary embodiment is in the arena or field of research teaming, the presently disclosed subject matter can be used for a wider setting of repeated teaming. For example, building teams in response more broadly to an opportunity is a common business activity. Examples include responding to calls for proposals in product and services supply chains, expert teams for a medical procedure at a hospital, players for a match for team-based sports, and crews for an airline flight. While this disclosure focuses on the example of teaming for researchers applying to funding agencies in response to their call for proposals (denoted herewith as TeamingForFunding), the subject disclosure and approach are applicable to all other such broader settings as well.

A large proportion of funding for research in public universities comes from funding agencies. Hence, it is very important for researchers to be able to identify funding opportunities and make successful proposals. Moreover, many of the opportunities are multidisciplinary, requiring teams to be quickly assembled from a wide variety of backgrounds who can work together. Currently, identifying the RFPs that suit the organization's experts' competence is all done by hand by the organization's administrators' and staffs' best know-how.

Today, there is limited automation to alert university researchers about available opportunities. One example is Pivot®, which sends keyword-based alerts to faculties whose interests match the areas listed in an RFP. Another system is Scry™, which matches proposals to faculty but does not identify teaming opportunities. Such systems do not have the capability to suggest people who should come together to form a team to respond to the RFP. Even in the alerts sent out by today's keyword-based systems, there is a high number of false positives (detects an opportunity where there is not) and false negatives (misses an opportunity which should have been flagged), making the alerts often unusable. As a result, whether such systems are available or not, faculties have to manually go to websites of funding agencies and keep track of RFPs that they may discover.

Some prior art describes systems and methods matching job descriptions to job seekers' resumes. Guo, S., Alamudun, F., & Hammond, T. (2016). RésuMatcher: A personalized resume-job matching system. Expert Systems with Applications, 60, 169-182, offers a statistical similarity index for ranking relevance between candidate résumés and a database of available jobs. It is an intelligent content-based job search engine using a finite-state transducer-based tool for information extraction, an automated technical skills dictionary builder, and an automated web crawler for job extraction and processing. It produces a statistical similarity index for resume-specific job relevance but does not function in the context of RFPs.

Maheshwary, S., & Misra, H. (2018, April) discloses matching resumes to jobs via deep siamese network. The Companion Proceedings of the Web Conference 2018 (pp. 87-88) refers to recommending appropriate jobs for job-seeking candidates by matching semi-structured resumes of candidates to job descriptions, which is not suitable for addressing RFPs.

Lin, Y., Lei, H., Addo, P. C., & Li, X. (2016) discloses machine-learned resume-job matching solution. arXiv preprint arXiv:1607.07657. Motahari-Nezhad, H. R., Cappi, J. M., Nakamurra, T., & Qiao, M. (2016, January). RFPCog discloses linguistic-based identification and mapping of service requirements in RFPs to IT service solutions. In the 2016 49th Hawaii International Conference on System Sciences (HICSS) (pp. 1691-1700), IEEE serves to automatically extract client requirements and understand how these requirements map to the internal offerings, products, or solutions of the business to improve the efficiency of preparing RFP responses, and to conduct sizing and pricing of the solutions, but it is also not suitable for team building functionality.

Dumais, S. T., & Nielsen, J. (1992, June) relates to automating the assignment of submitted manuscripts to reviewers. In Proceedings of the 15th annual International ACM SIGIR conference on Research and Development in Information Retrieval (pp. 233-244), an automated assignment method called “n of 2n” achieves better performance than human experts by sending reviewers more papers than they actually have to review and then allowing them to choose part of their review load themselves. Such functionality does not include expert matching to proposals and would not function in the case of RFPs.

The patent literature has addressed resume handling, some examples of which are as follows. US20120330708A1 describes a system and method that permits hiring managers and jobseekers to receive a ranked list of matching resumes for their posted jobs and resumes respectively. The validated jobs and resumes are automatically matched by the matching engine creating a ranked list of resumes for each job and jobs for each resume. To function, US20120330708A1 is dependent on the structure of the job resume and the job advertisement descriptions.

U.S. Pat. No. 8,595,149B1 describes a computer system and method for managing access to a resume database, where for each skill or experience-related phrase in a resume, the system calculates the number of occurrences. The system is intended for a recruiter who searches the resume database to find matching resumes that satisfy a job description.

US20140122355A1 describes a computer-based method, and computer system, for matching candidates with job openings. The described technology relates to methods of providing a candidate with a score for a particular job opening, where the score is derived from a comparison of features in the candidate's resume with job features in a description of the job opening, as well as use of external data gathered from other sources such as social media and based on information contained in the candidate's resume and/or in the description of the job opening.

U.S. Pat. No. 8,433,713B2 and US20150235181A1 both describe a job searching and matching system and method that gathers job seeker information, gathers job information, correlates the information with past job seeker behavior, responds to a job seeker's query, and provides matching job results along with suggested alternative jobs. The system can also respond to the employer's corresponding query when looking for the candidates.

Some patent literature relates to systems for matching investments for project funding. US20040153388A1 describes an investment funds management strategy and system which utilizes low yield or no yield marginable assets to act as collateral to secure a credit facility.

US20060031078A1 describes a system and method for electronically receiving, evaluating, and processing project requests, and for monitoring the progress of developing requested projects through implementation. Electronic processing of project requests includes initiating a system request; directing the request to the appropriate business for review; generating cost and estimates for the requested project; generating preliminary start and end dates for the project; classifying the project based upon its size (cost expectations); acquiring funding for the project; and monitoring the project toward completion.

US20060031078A1 describes a system and a method for project requests within an organization.

Other patent literature may relate to searching experts to match reviewers to scientific papers or to identify a right expert for a given task. For instance, U.S. Pat. No. 7,219,301B2 describes a method of accepting a paper for peer review, randomly assigning the paper to one or more of a defined set of reviewers for review, and providing one or more criteria to be used for reviewing and evaluating each paper to the reviewers.

U.S. Pat. No. 8,150,750B2 describes a system and a method for managing consultation requests to communities of experts, including receiving consultation requests and responses to consultation requests.

U.S. Pat. No. 7,819,735B2 describes a system and method for playing a team gaming tournament that allows players to form teams of one or more players in order to allow a team's performance in a gaming tournament to be dependent on both the performance of each individual member of the team as well as the number of players on each team.

U.S. Pat. No. 9,155,968B2 describes a method enabling a player to use remote home terminals or mobile devices via a network to enroll in a casino tournament gaming system. The system uses existing social networks to leverage pre-existing relationships between players that are members of the social network to form tournament teams.

Generally, such existing approaches are not able to analyze requests for proposals and match them to suitable candidates within an organization staff.

The presently disclosed system provides that, given RFP from funding agencies like NSF, DOE and NASA, a team of experts is recommended from various faculties and departments of the university that would best fit the needs of the RFP and would have a high chance of putting a successful proposal together. Since many of the proposals are multidisciplinary, the recommended team would be have complementary skills and be prioritized for those who have worked together successfully in the past.

The presently disclosed system would offer a competitive advantage over doing the work manually as it promptly responds to RFPs, hence saving valuable project writing time. Within an organization, available and dynamically changing teaming opportunities would be discovered because the team would be suggested based on latest data independent of personal bias or preferences.

### SUMMARY OF THE PRESENTLY DISCLOSED SUBJECT MATTER

The presently disclosed computer system and corresponding and/or associated computer methodology, given RFPs from funding agencies like NSF, DOE and NASA, recommends a team of experts from various faculties and departments of the organization (e.g., a university) that would best fit the needs of an RFP and have a high chance of putting a successful proposal together. The system relies on public data and can use additional data where available. The system, in some embodiments, can be described by INPUT comprising RFPs and researchers' public information, and by OUTPUT comprising lists of proposed teams, each team with two or more members.

Optionally, the output may provide an estimation budget for each team and proposed chances for success.

In one exemplary embodiment disclosed herewith, a system and method for building teams for RFPs is described. It is to be understood that while such exemplary embodiment is in the arena or field of research teaming, the presently disclosed subject matter can be used for a wider setting of repeated teaming. For example, building teams in response more broadly to an opportunity is a common business activity. Examples are responding to calls for proposals in product and services supply chains, expert teams for a medical procedure at a hospital, players for a match for team-based sports, and crews for an airline flight. While this disclosure focuses on the example of teaming for researchers applying to funding agencies in response to their call for proposals (denoted herewith as TeamingForFunding), the subject disclosure and approach are applicable to all other such broader settings as well.

It is to be understood that the presently disclosed subject matter equally relates to associated and/or corresponding methodologies. One exemplary such method relates to methodology for addressing teaming comprising maintaining a database of active teaming opportunities; maintaining a database of profile data of potential team participants available at a given institution; extracting capabilities needed to fulfill an individual teaming opportunity from the database of teaming opportunities; matching the extracted capabilities data with profile data of potential team participants; identifying and creating a proposed team comprised of members from potential personnel at the given institution matched for forming a team; and notifying the proposed team members of their identification to a proposed team for the individual teaming opportunity.

Another exemplary such method relates to methodology for addressing research RFPs comprising maintaining a database of active research RFPs from grant funding agencies; maintaining a database of profile data of research personnel available at a given institution; extracting requirements data for an individual RFP from the updated database of active research RFPs; matching the extracted requirements data with profile data of research personnel; identifying and creating a proposed team comprised of members of the available research personnel at the given institution matched for submitting on the individual RFP; and notifying the proposed team members of their identification to a proposed team for the individual RFP.

Yet another exemplary such method in accordance with presently disclosed subject matter relates to methodology for assisting an institution to address teaming opportunities comprising maintaining an updated database of teaming opportunities; maintaining an updated database of profile data of personnel available at the institution; extracting requirements data from the updated database of teaming opportunities; conduct best-fit matching of the extracted requirements data with profile data of personnel to identify available personnel at the institution matched for submitting on a given teaming opportunity; creating at least one proposed team comprised of at least two members of the matched personnel with a high chance of putting a successful proposal together for a given teaming opportunity; and notifying an administrative user at the institution of the proposed team and the given teaming opportunity.

A more specific additional exemplary such method in accordance with presently disclosed subject matter relates to methodology for assisting an institution to address research RFPs comprising maintaining an updated database of active research RFPs from grant funding agencies; maintaining an updated database of profile data of research personnel available at the institution; extracting requirements data from the updated database of active research RFPs; conduct best-fit matching of the extracted requirements data with profile data of research personnel to identify available research personnel at the institution matched for submitting on a given individual RFP; creating at least one proposed team comprised of at least two members of the matched research personnel with a high chance of putting a successful proposal together for a given individual RFP; and notifying an administrative user at the institution of the proposed team and the given individual RFP.

Other example aspects of the present disclosure are directed to systems, apparatus, tangible, non-transitory computer-readable media, user interfaces, memory devices, and electronic devices for ultrafast photovoltaic spectroscopy. To implement methodology and technology herewith, one or more processors may be provided, programmed to perform the steps and functions as called for by the presently disclosed subject matter as will be understood by those of ordinary skill in the art.

Another exemplary embodiment of presently disclosed subject matter relates to a system for addressing research RFPs. Such system may preferably comprise an RFP database of active research RFPs from grant funding agencies; a personnel database of profile data of research personnel available at a given institution; and one or more processors programmed for extracting requirements data for an individual RFP from the updated database of active research RFPs; matching the extracted requirements data with profile data of research personnel; identifying and creating a proposed team comprised of members of the available research personnel at the given institution matched for submitting on the individual RFP; and notifying the proposed team members of their identification to a proposed team for the individual RFP.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying figures, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates an augmented block diagram of an exemplary embodiment of presently disclosed system architecture illustrating representative incorporation of a user (for example, a university administrator);

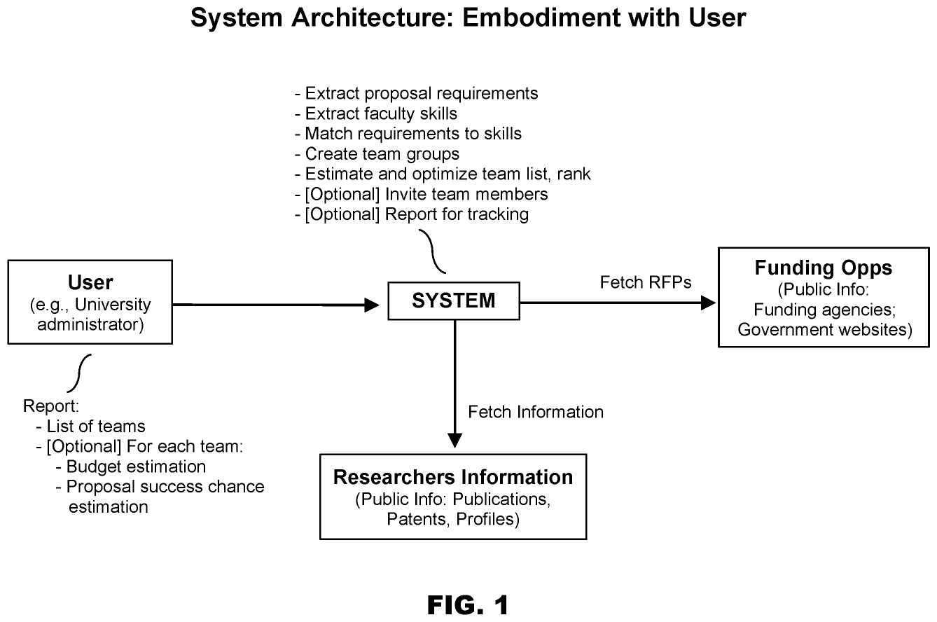

FIG. 2 illustrates an augmented block diagram of an exemplary embodiment of presently disclosed system architecture without illustrating representative incorporation of a user; and

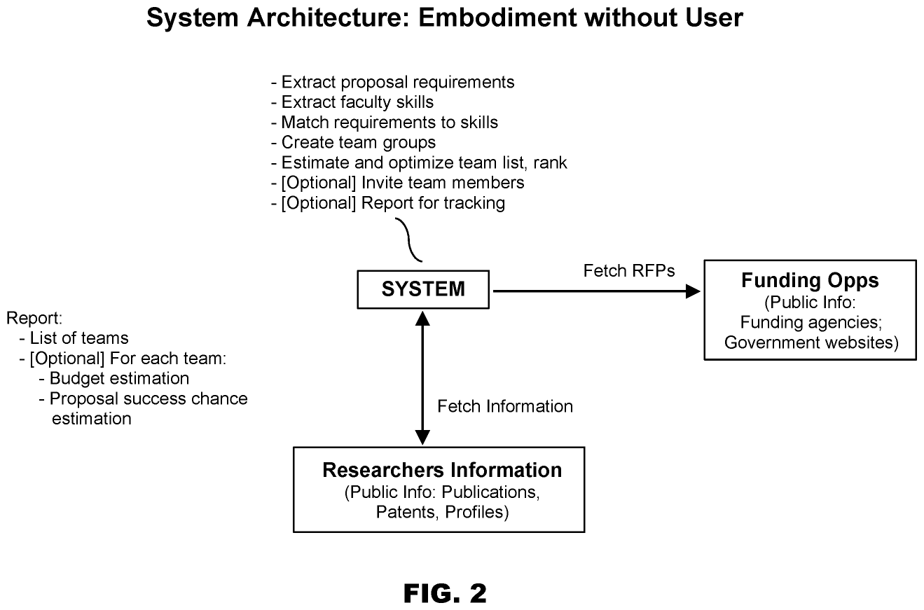

FIG. 3 illustrates an exemplary embodiment of presently disclosed subject matter showing flow chart representations of interactions in an exemplary preferred embodiment.

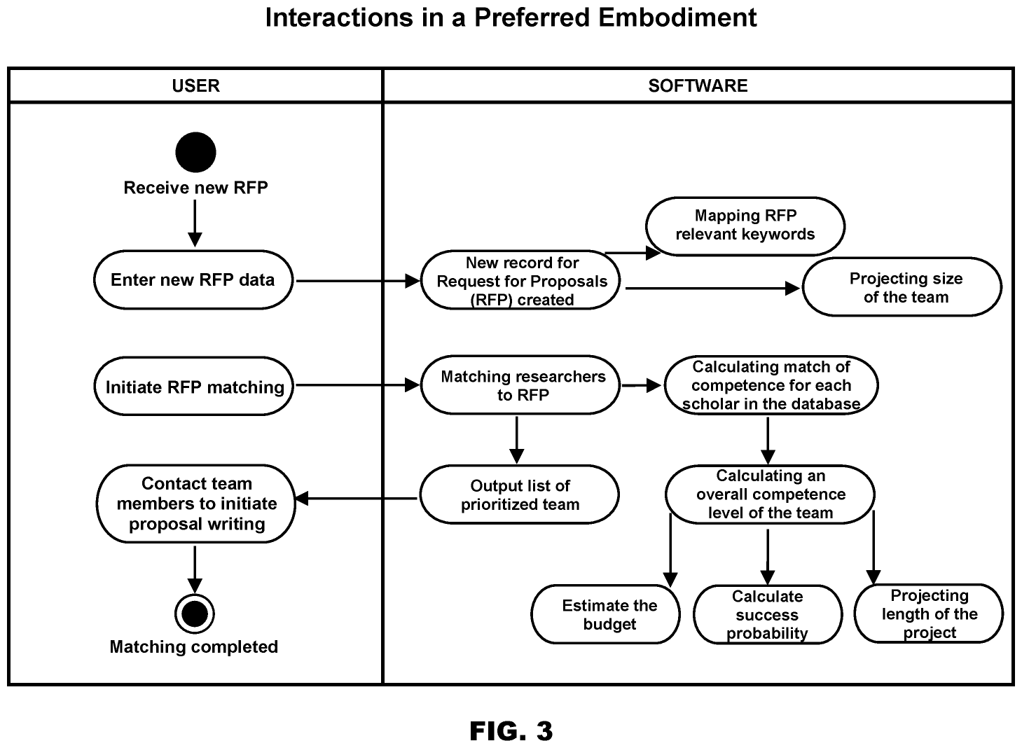

Repeat use of reference characters in the present specification and drawings is intended to represent the same or analogous features or elements of the present invention.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

In general, the present disclosure is directed to a system which is a data-driven, university-wide solution that will automate the processing of suggesting leads for team formation to respond to RFPs. The AI-based system uses primarily natural language processing and analytical/optimization techniques to output one or more teams and estimates for success along critical key indicators. The system can be described by INPUTS-RFPs, researchers' public information—and OUTPUTS—lists of proposed teams, each team with two or more members.

At the core, the system will rely primarily on public data. Examples of such data and their respective sources may include the following RFP information: One or more from 1) Commerce Business Daily is now (Federal Business Opportunities) FedBizOpps, which can be searched from http://cbd-net.com/; 2) GRANTS.gov https://www.grants.gov; 3) FedConnect® https://www.fedconnect.net; and 4) Foundation Directory Online https://fconline.foundationcenter.org. Other examples of such data and their respective sources may include the following faculty skills and interests from one or more faculty web pages or from Google Scholar™, and from successful proposals from one or more funding agencies sites, such as NSF, DOE, and NASA.

Stakeholders of the system are faculty members and proposal offices/business divisions which support proposal management; IT departments that operate university-wide systems; and funding agencies and sponsors of the studies.

Per presently disclosed subject matter, the user (administrator) of the system may be explicitly present, present for some steps, or completely absent. A faculty member, e.g., researcher, may be, by default, opted-in to participate in a team (if selected). Alternatively, the system may inform potential team members and then generate final teams.

The proposed system newly discloses the following combined attributes and functionalities. The system generates teams that may match requirements of an RFP. Next, the system is optimizing the list of teams to maximize winning success and to reduce redundancy. Also, the system is estimating the team budget and the team's success chances by proposal success chance/probability estimation.

The system also improves estimation based on researchers' historical collaboration data success of historical teams.

Preparatory Steps to providing a team solution may include the following:
Extracting requirements from RFPs, e.g., the fields of activity, expected outcome, budget, deadlines. RFP info can be gathered by accessing RFPs by URL or other documents. Information can be collated from multiple sources for RFPs. RFP information fields are identified, and text, graphs, etc. are fetched.
Extracting skills from researcher profile(s), e.g., in skill areas, experience level, and past collaborators. Researcher information is fetched by accessing their profiles from URL or other documents. Information can be collated from multiple profiles. Information fields in researcher profiles are identified and relevant information provided to the system.

Matching requirements with skills and getting potential leaders may include:
“Create team groups” steps include creating a team with an anchor Principal Investigator (PI) based on overlap of researchers' skills and requirements, and in the context of a lead, based on matching necessary and compatible researchers. Optionally, the system checks PI/co-PI eligibility requirements. In addition, the system accounts for preset incorporated success and diversity preferences.
“Estimate and optimize” steps include selecting non-dominating teams based on match and estimating team's statistics, whereas, optionally, estimating the budget, in addition to estimating the team's success chance and outputting a list of prioritized teams.

The team information is sent to team members and the user, if present. People in the prioritized list of potential teams are notified about the RFP and asked if they have both interest and time. The response would be a Yes or No. If there are sufficient positive responses in a team, the teaming commences, enabled by the system.

The system can be a web-based application or a stand-alone application running from a personal computer. The data inputs will be entered as URL, as .PDF/.TXT, or other files. The system's output will be printable.

The presently disclosed subject matter newly presents features such as 1) the idea of generating teams that may match requirements of an RFP; 2) optimizing a list of teams to maximize winning success and reduce redundancy; 3) estimating the team budget; 4) estimating the team's success chances; 5) estimating the proposal success chance/probability; and 6) estimating the project budget. The system improves estimations based on the researcher's historical collaboration data, the success of historical teams, and the researcher opt-in and notification methods.

Embodiment Variations may include the following examples:
User is explicitly present, present for some steps, or completely absent;
Researcher is, by default, opted-in to participate in a team, or the system informs potential team members and then generates final teams.

RFP information:
Access to RFP-URL, document
Collating information from multiple sources for RFP
Information fields in RFPs.

Researcher information:
Access to profile-URL, document
Collating information from multiple profiles
Information fields in the researcher profile.

Notification method:
Team information is sent to
Team members or
User, if present.

Presently disclosed subject matter relates to the areas of RFP response, skill matching, and optimal teams.

Presently disclosed subject matter in another embodiment also relates to a computer-based system and implemented method, which, given the requirements in an RFP and a set of available researchers with their research profiles, produce a list of teams, such steps comprising:
Extracting requirement from RFPs,
Extracting skills from researcher profiles,
Matching requirements to skills,
Creating team groups,
Estimating and optimizing teams in a list and ranking them for priority.

Another example relates to the above type of methodology, and further, where the system improves estimation based on a researcher's historical collaboration data.

In some embodiments, the presently disclosed system relates to a system for team formation where the system invites teams in the list for collaboration. Another embodiment may relate to a system for team formation where the system tracks team members for their response to invitation and, further, sends reminders.

The presently disclosed subject matter has potential interest for all universities, colleges, all research organizations, and also large companies who have research departments of a comparable capacity to colleges.

The presently disclosed subject matter provides a competitive advantage over attempting to doing the work manually because it promptly and timely responds to RFPs, which saves valuable project writing time.

Within an organization, available and dynamically changing teaming opportunities would be discovered because the team would be suggested based on the latest data independent of personal bias or preferences.

All universities face the need for teaming opportunities and the problem of personal biases or preferences. Therefore, the scope of use could encompass the 261 top research universities and the 4,298 degree-granting postsecondary institutions in the U.S. (as of the 2017-2018 school year). Federal funding for research in 2018 topped $127.2 billion, most allotted to universities. There are about 1 million researchers in these universities who could be affected.

While certain embodiments of the disclosed subject matter have been described using specific terms, such description is for illustrative purposes only. For example, use herewith of the terminology “the institution” or “at the given institution” may, in fact, refer to a single entity, or in some instances, may refer to a group of entities which are related to each other, such as under a common umbrella, or in other instances, related such as through some other agreement or mechanism for potentially sharing access to personnel for purposes of forming a team or teams in accordance with presently disclosed subject matter. Accordingly, it is to be understood that all such changes and variations may be made without departing from the spirit or scope of the presently disclosed and/or claimed subject matter.

What is claimed is:

1. Methodology for addressing teaming, comprising:
maintaining a database of active teaming opportunities;
maintaining a database of profile data of potential team participants available at a given institution;
extracting capabilities needed to fulfill an individual teaming opportunity from the database of teaming opportunities;
matching the extracted capabilities data with profile data of potential team participants;
identifying and creating a proposed team comprised of members from potential personnel at the given institution matched for forming a team; and
notifying the proposed team members of their identification to a proposed team for the individual teaming opportunity.

2. Methodology as in claim 1, wherein:
the teaming opportunity is for Requests for Proposals (RFPs);
potential team members are research personnel; and
the purpose of a team is to submit a proposal in response to an RFP.

3. Methodology as in claim 2, further including periodically updating the database of RFPs and the database of research personnel so that dynamically changing teaming opportunities within research personnel available at a given institution are discovered based on latest profile data independent of bias or preferences.

4. Methodology as in claim 2, wherein notifying includes inquiring of the individual proposed team members their potential interest in participating on submitting for the individual RFP.

5. Methodology as in claim 2, wherein the individual RFP is multi-disciplinary, and the proposed team members have complementary skills.

6. Methodology as in claim 1, wherein identifying and creating a proposed team prioritizes personnel identification based on those who have worked together successfully in the past.

7. Methodology as in claim 2, wherein:
maintaining the database of active research RFPs includes collating information from multiple sources for RFPs; and
extracting requirements data for an individual RFP includes extracting data from selected information fields in RFPs.

8. Methodology as in claim 2, further including notifying an administrative user at the given institution of the identification of a proposed team for an individual RFP.

9. Methodology as in claim 2, wherein the profile data of research personnel includes at least one of skillset, expertise, and experience for available research personnel.

10. Methodology for assisting an institution to address teaming opportunities, comprising:
maintaining an updated database of teaming opportunities;
maintaining an updated database of profile data of personnel available at the institution;
extracting requirements data from the updated database of teaming opportunities;
conducting best-fit matching of the extracted requirements data with profile data of personnel to identify available personnel at the institution matched for submitting on a given teaming opportunity;
creating at least one proposed team comprised of at least two members of the matched personnel with a high chance of putting a successful proposal together for a given teaming opportunity; and
notifying an administrative user at the institution of the proposed team and the given teaming opportunity.

11. Methodology as in claim 10, further including:
creating a plurality of proposed teams for a given teaming opportunity;
prioritizing the plurality of proposed teams based on relative projected team success; and
notifying the administrative user at the institution of the proposed teams and their relative rankings.

12. Methodology as in claim 10, further including estimating team budgets.

13. Methodology as in claim 10, further including notifying the proposed team members of their identification to a proposed team for the given teaming opportunity to obtain their opt-in or opt-out feedback.

14. Methodology as in claim 10, wherein extracting requirements data from the updated database of teaming opportunities includes focus on pre-determined keywords, topics, and concepts of selected interest for an institution.

15. Methodology as in claim 10, wherein said teaming opportunities comprise responding to one of proposals in product and services supply chains, expert teams for a medical procedure at a hospital, players for a match for team-based sports, crews for a flight or mission, and active research RFPs from grant-funding agencies

16. Methodology as in claim 10, wherein:
said teaming opportunities comprise active research RFPs from grant-funding agencies; and
said personnel comprise research personnel available at the institution.

17. Methodology as in claim 16, wherein matching includes checking research personnel eligibility to participate in a given individual RFP.

18. Methodology as in claim 16, further including notifying the proposed team members of their identification to a proposed team for the given individual RFP teaming opportunity to obtain their opt-in or opt-out feedback.

19. Methodology as in claim 16, further including:
creating a plurality of proposed teams for a given teaming opportunity;
prioritizing the plurality of proposed teams based on relative projected team success; and
notifying the administrative user at the institution of the proposed teams and their relative rankings.

20. Methodology as in claim 19, wherein prioritizing based on relative projected team success includes making estimations based on matched research personnel historical collaboration data.

21. Methodology as in claim 19, wherein prioritizing includes optimizing the proposed teams to maximize winning success and reduce redundancy.

22. Methodology as in claim 19, wherein prioritizing includes optimizing the proposed teams to incorporate success and diversity preferences about teams.

23. A system for addressing research Requests for Proposals (RFPs) comprising:
an RFP database of active research RFPs from grant-funding agencies;
a personnel database of profile data of research personnel available at a given institution; and
one or more processors programmed for
extracting requirements data for an individual RFP from the updated database of active research RFPs;
matching the extracted requirements data with profile data of research personnel;
identifying and creating a proposed team comprised of members of the available research personnel at the given institution matched for submitting on the individual RFP; and
notifying the proposed team members of their identification to a proposed team for the individual RFP.

24. A system as in claim 23, wherein said RFP database and said personnel database each comprise one or more network-based non-transitory storage devices.

25. A system as in claim 24, wherein said one or more processors are further programmed for periodically updating at least one of the RFP database and personnel database, so that dynamically changing teaming opportunities within research personnel available at a given institution are discoverable based on latest profile data independent of bias or preferences.

26. A system as in claim 25, wherein said one or more processors further comprise an AI-based system using primarily natural language processing and analytical/optimization techniques.

27. A system as in claim 25, wherein said one or more processors are further programmed:
for periodically updating said RFP database for collating and storing information from multiple sources for RFPs; and
for extracting data from selected information fields in RFPs.

28. A system as in claim 23, wherein said system comprises one of a web-based application and of a stand-alone application running on a personal computer.

29. A system as in claim 23, wherein the individual RFP is multi-disciplinary, and the proposed team members have complementary skills.

30. A system as in claim 23, wherein said one or more processors are further programmed for prioritizing personnel identification based on those who have worked together successfully in the past.

31. A system as in claim 23, wherein said one or more processors are further programmed for notifying an administrative user at the given institution of the identification of a proposed team for an individual RFP.

32. A system as in claim 23, wherein the profile data of research personnel includes at least one of skillset, expertise, and experience for available research personnel.
